(19) United States
(12) Patent Application Publication
(10) Pub. No.: US 2012/0036708 A1
(43) Pub. Date: Feb. 16, 2012

(54) CRIMPING TOOL

(76) Inventor: Yueh-Chiung LU, Tao-Yuan County (TW)

(21) Appl. No.: 13/074,701

(22) Filed: Mar. 29, 2011

(30) Foreign Application Priority Data
Aug. 10, 2010 (TW) 099215302

(51) Int. Cl. H01R 43/042

(52) U.S. Cl. 29/751

(57) ABSTRACT

A crimping tool for crimping a coaxial cable with a cable-end connector is disclosed to include a tool body, a lever pivoted to the tool body, and a linking mechanism having a link axially slidably coupled to the tool body inside the accommodation chamber and movable by the lever, a locating block located on one end of the link opposite to the lever and a working device consisting of a shank, a connection member, an expanded working head, a sliding socket and a spring member and connected to the locating block for crimping a coaxial cable with a cable-end connector of any of a variety of different sizes accurately and rapidly with less effort.

This application claims the priority benefit of Taiwan patent application number 099215302, filed on Aug. 10, 2010.

### BACKGROUND OF THE INVENTION

1. Field of the Invention

The present invention relates to a hand tool for crimping a coaxial cable with a cable-end connector and more particularly, to a crimping tool, which is practical for crimping a coaxial cable with a cable-end connector of any of a variety of different sizes accurately and rapidly with less effort.

2. Description of the Related Art

When connecting a cable-end connector to a coaxial cable, a crimping tool must be used to crimp the coaxial cable with the cable-end connector so that the cable-end connector can be firmly secured to the coaxial cable. FIG. 7 illustrates a conventional scissor type crimping tool. According to this design, the scissor type crimping tool comprises a connection block A having a cable hole A1, a first plier member B pivoted to a first side A2 of the connection block A, a first spring B1 mounted on the top end of the first plier member B, a second plier member C pivoted to a second side A3 of the connection block A, a second spring C1 mounted on the top end of the second pilfer member C, a slide D disposed at the bottom side of the cable hole A1 and having a top press portion D1, a link E having a first end E2 pivotally connected to the first plier member B and a second end E1 pivotally coupled to a first side D2 of a link E, and a second link F having a first end F2 pivotally connected to the second plier member C and a second end F1 pivotally connected to a second side D3 of the slide D. When the first plier member B and the second pilfer member C are moved toward each other, the first link E and the second link F are forced to move the slide D linearly relative to the connection block A, thereby crimping a cable H with a cable-end connector G that are set between the slide D and the connection block A.

Because the size of the cable-end connector G varies from different models and different suppliers, the fixed configuration of the top press portion D1 of the slide D cannot fit all different sizes of cable-end connector G. To solve this problem, different sizes of detachable top press portions D1 may be selectively used with the slide D so that one single crimping tool can be used for crimping different sizes of cable-end connector G.

However, it is complicated to change the detachable top press portion D1, wasting much labor and time.

### SUMMARY OF THE INVENTION

The present invention has been accomplished under the circumstances in view. It is one object of the present invention to provide a crimping tool, which is practical for crimping a coaxial cable with a cable-end connector of any of a variety of different sizes accurately and rapidly with less effort.

To achieve this and other objects of the present invention, a crimping tool comprises a tool body, a lever pivoted to the tool body, and a linking mechanism having a link axially slidably coupled to the tool body inside the accommodation chamber and movable by the lever, a locating block located on one end of the link opposite to the lever and a working device consisting of a shank, a connection member, an expanded working head, a sliding socket and a spring member and connected to the locating block for crimping a coaxial cable with a cable-end connector of any of a variety of different sizes accurately and rapidly with less effort. If the inner diameter of the collar of the cable-end connector to be crimped is greater than the outer diameter of the sliding socket, the working head with the sliding socket can be directly inserted into the inside of the collar. If the inner diameter of the collar is smaller than the outer diameter of the sliding socket but greater than the working head of the working device, attaching the collar to the working head will push the sliding socket toward the locating block to compress the spring member, and thus, the collar can be attached to the working head smoothly. Thus, the crimping tool of the invention is practical for crimping any of a variety of cable-end connectors with a coaxial cable.

### BRIEF DESCRIPTION OF THE DRAWINGS

FIG. 1 is a sectional side view of a crimping tool in accordance with the present invention.

FIG. 2 is a sectional view, in an enlarged scale, of the working device shown in FIG. 1.

FIG. 2A is a top view of the working device of the crimping tool in accordance with the present invention.

FIG. 3 is a schematic sectional side view of the present invention illustrating a coaxial cable with a cable-end connector set in the tool body of the crimping tool and crimped.

FIG. 4 is a schematic sectional applied view of the present invention, illustrating a coaxial cable attached with a cable-end connector set before crimping.

FIG. 4A corresponds to FIG. 4, illustrating the working head with the sliding socket entered the collar of the cable-end connector.

FIG. 5 is another schematic sectional applied view of the present invention, illustrating a coaxial cable with a cable-end connector attached to the working device of the crimping tool and the sliding socket stopped outside the collar of the cable-end connector.

FIG. 5A corresponds to FIG. 5, illustrating the coaxial cable and the cable-end connector crimped.

FIG. 6 is still another schematic sectional applied view of the present invention, illustrating a coaxial cable with a cable-end connector attached to the working device of the crimping tool and the center conductor of the cable-end connector inserted through the receiving hole of the working head before crimping.

FIG. 6A corresponds to FIG. 6, illustrating the coaxial cable and the cable-end connector crimped.

FIG. 7 is a schematic plain view of a scissor type crimping tool according to the prior art.

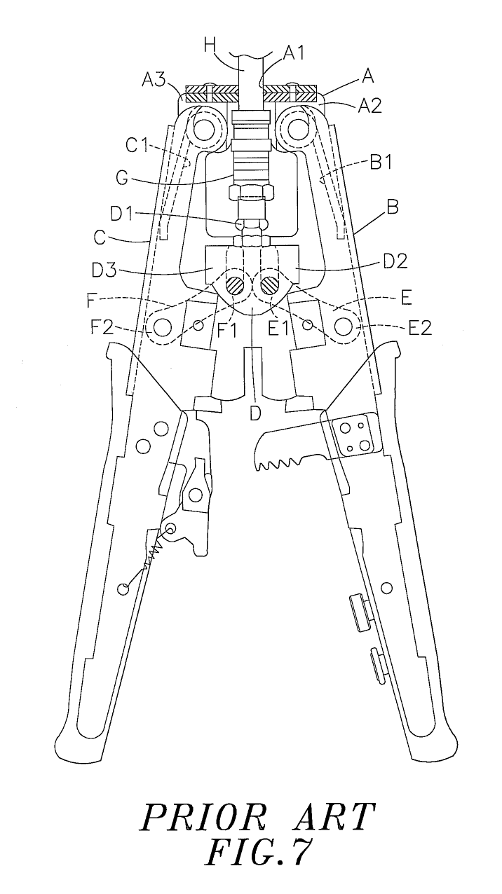

### DETAILED DESCRIPTION OF THE PREFERRED EMBODIMENT

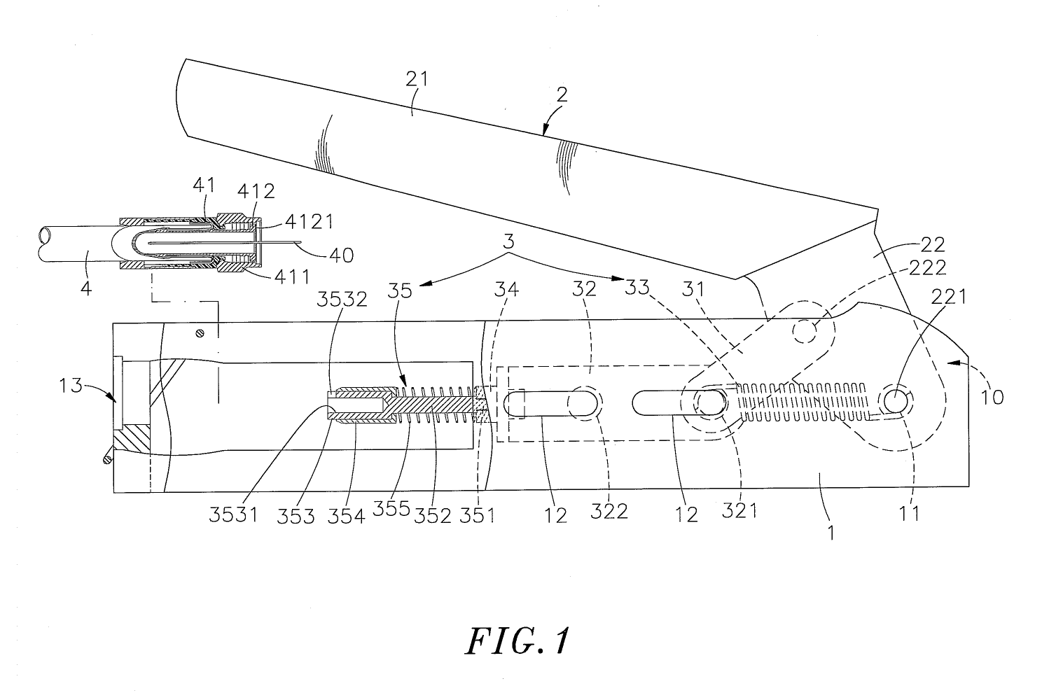

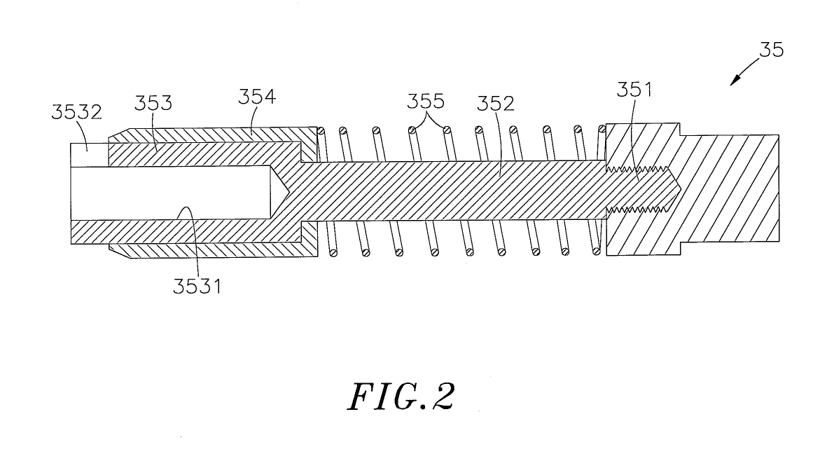

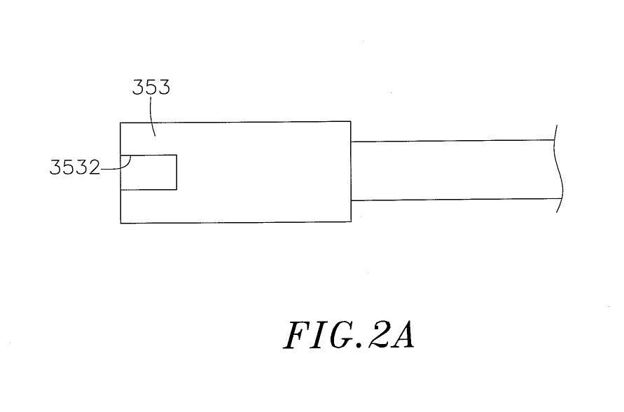

Referring to FIGS. 1, 2 and 2a, a crimping tool in accordance with the present invention is shown comprising a tool body 1, a lever 2, and a linking mechanism 3.

The tool body 1 comprises a receiving chamber 10, a pivot hole 11 cut through each of the two opposite lateral sides thereof and disposed in communication with the receiving chamber 10 near its one end, first and second longitudinal sliding slots 12 cut through each of the two opposite lateral sides thereof and horizontally aligned in line and disposed in communication with the receiving chamber 10, and a positioning block 13 mounted in one end of the receiving chamber 10 remote from the first and second longitudinal sliding slots 12 and the pivot hole 11.

The lever 2 comprises a front connection portion 22, a rear operating portion 21 backwardly extended from a rear end of the front connection portion 22 at an obtuse angle, a first pivot 221 located on a front end of the front connection portion 22 remote from the rear operating portion 21 and pivotally connected between the two pivot holes 11 of the tool body 1, and a second pivot 222 located on the front connection portion 22 near its one side and spaced between the rear operating portion 21 and the first pivot 221.

The linking mechanism 3 is mounted in the receiving chamber 10 of the tool body 1, comprising two swivel pushrods 31, a link 32, spring members 33, a locating block 34 and a working device 35. The swivel pushrods 31 each have one end respectively pivotally connected with the two distal ends of the second pivot 222 of the lever 2 and its opposite end pivotally connected to one end of the link 32. The link 32 comprises a first transverse coupling rod 321 located on its one end and pivotally coupled to the opposite end of each of the two swivel pushrods 31 and slidably coupled between the two first ones of the first and second longitudinal sliding slots 12 of the tool body 1, and a second transverse coupling rod 322 slidably coupled between the two second ones of the first and second longitudinal sliding slots 12 of the tool body 1. The spring members 33 are connected between the first pivot 221 of the lever 2 and the first transverse coupling rod 321 of the link 32. The locating block 34 is located on the opposite end of the link 32 remove from the first transverse coupling rod 321 and the second transverse coupling rod 322. The working device 35 comprises a shank 352, a connection member 351 axially extended from one end of the shank 352 and fastened to the locating block 34, an expanded working head 353 located on the opposite end of the shank 352 remote from the connection member 351, a sliding socket 354 axially slidably coupled to the shank 352 and adapted for capping onto the working head 353, and a spring member 355 mounted around the shank 352 and stopped between the locating block 34 and the sliding socket 354 to force the sliding socket 354 onto the working head 353. The working head 353 has a receiving hole 3531 axially extending to the front end thereof and facing the positioning block 13 for receiving the center conductor 40 of the cable-end connector 41 to be crimped, and a notch 3532 cut through the periphery and facing the rear operating portion 21 of the lever 2 for the passing of the center conductor 40 if the cable-end connector 41 is too thick or too long.

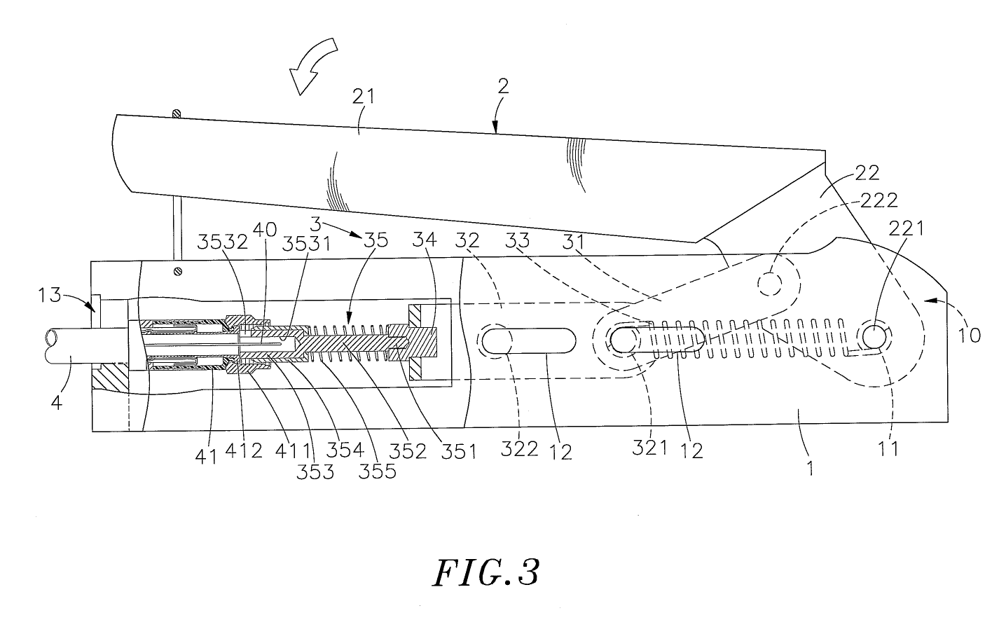

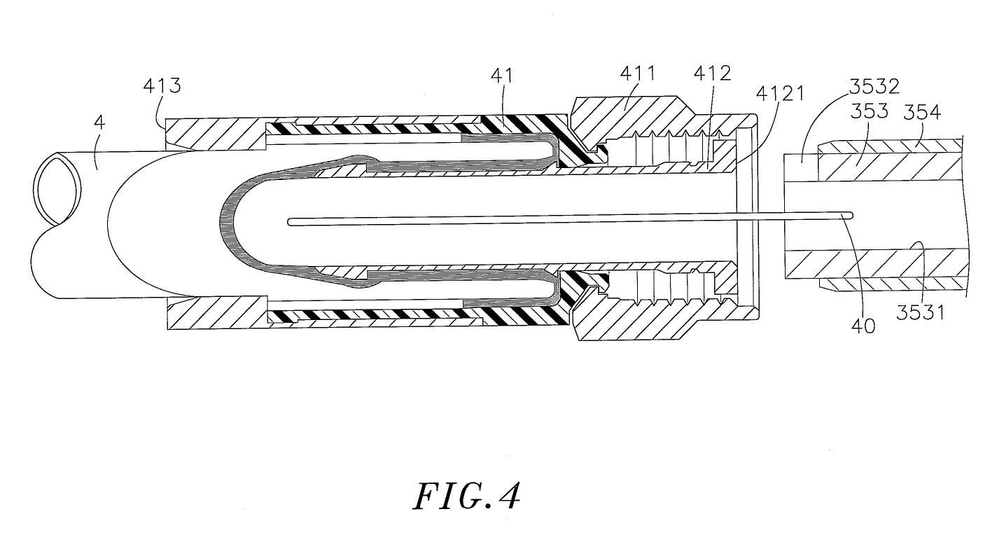

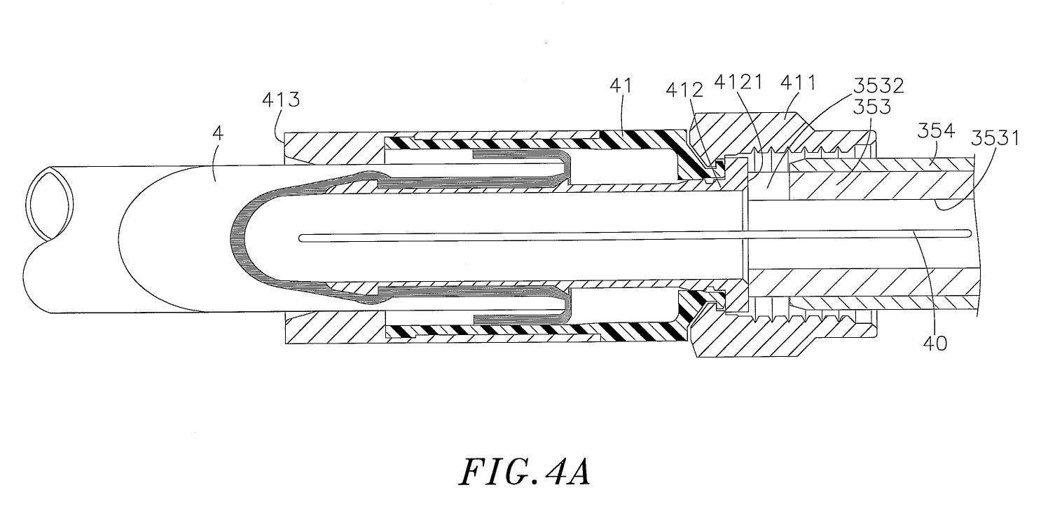

Referring to FIGS. 3, 4 and 4A and FIG. 1 again, when pressing down the rear operating portion 21 of the lever 2 toward the tool body 1, the two swivel pushrods 31 of the linking mechanism 3 will be forced by the front connection portion 22 to bias in direction toward the positioning block 13 and to push the first transverse coupling rod 321 and second transverse coupling rod 322 of the link 32 along the first and second longitudinal sliding slots 12 of the tool body 1 toward the positioning block 13, causing the spring members 33 to be stretched. At this time, the locating block 34 and the working device 35 are forced forwards by the link 32 toward the positioning block 13. When the biasing force is released from the rear operating portion 21 of the lever 2, the spring members 33 immediately return the swivel pushrods 31, the link 32, the locating block 34 and the working device 35, causing the lever 2 to be moved back to its former position by the swivel pushrods 31.

During a crimping operation, the coaxial cable 4 to be crimped is positioned in the positioning block 13 of the tool body 1, and the cable-end connector 41 that is attached to the coaxial cable 4 before crimping is inserted into the receiving chamber 10 of the tool body 1, enabling the collar 411 of the cable-end connector 41 to be attached to the working head 353 of the working device 35. when pressing down the rear operating portion 21 of the lever 2 toward the tool body 1 at this time, the working head 353 of the working device 35 will be moved forwards to push a stop flange 4121 of a core tube 412 of the cable-end connector 41 in direction toward a retaining portion 413 of the cable-end connector 41, finishing the crimping operation. As the crimping stroke between the collar 411 and the retaining portion 413 of any of a variety of different cable-end connectors 41 is the same, when the biasing force is released from the lever 2, the spring members 33 immediately return the component parts of the crimping tool to their former positions. Thus, the coaxial cable 4 and the cable-end connector 41 are well crimped.

Referring to FIGS. 1, 2, 2A and 3 again, if the center conductor 40 of the cable-end connector 41 is too thick or too long and cannot be directly inserted into the inside of the receiving hole 3531 of the working head 353 during insertion of the cable-end connector 41 with the coaxial cable 4 into the receiving chamber 10 of the tool body 1, the center conductor 40 can be directly inserted through the notch 3532 and then set in the receiving hole 3531 of the working head 353, facilitating positioning of the coaxial cable 4 with the cable-end connector 41 in the tool body 1 of the crimping tool.

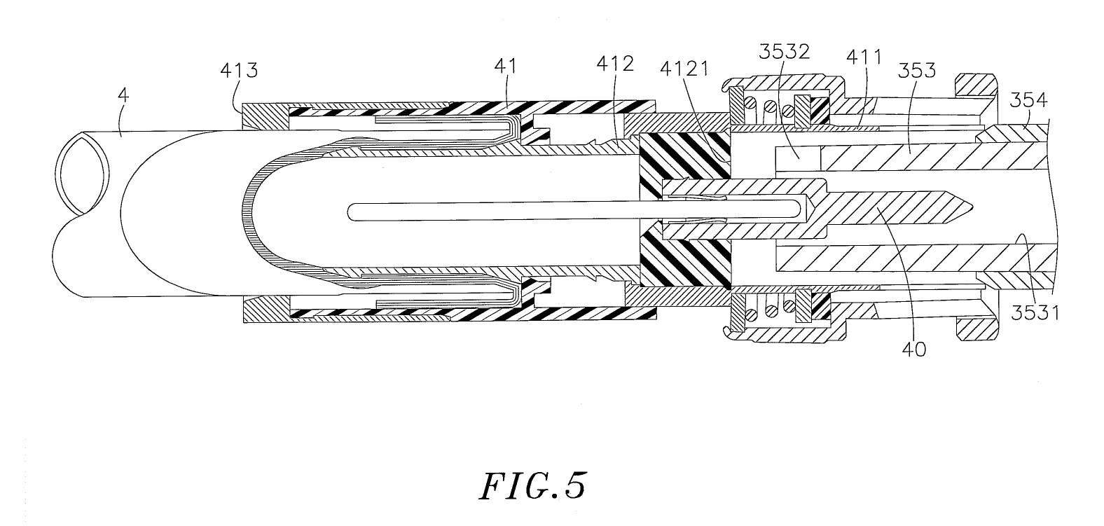

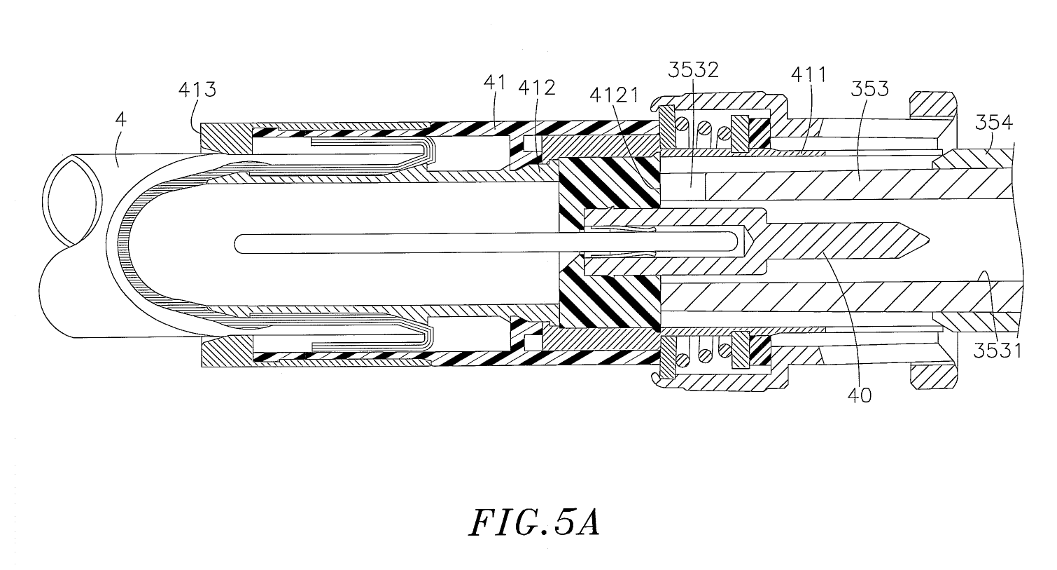

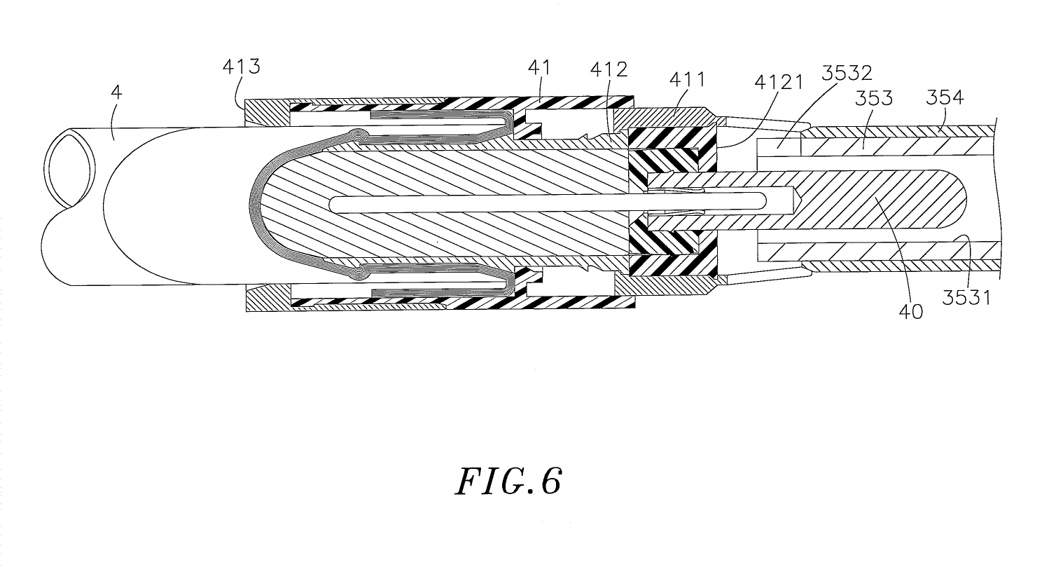

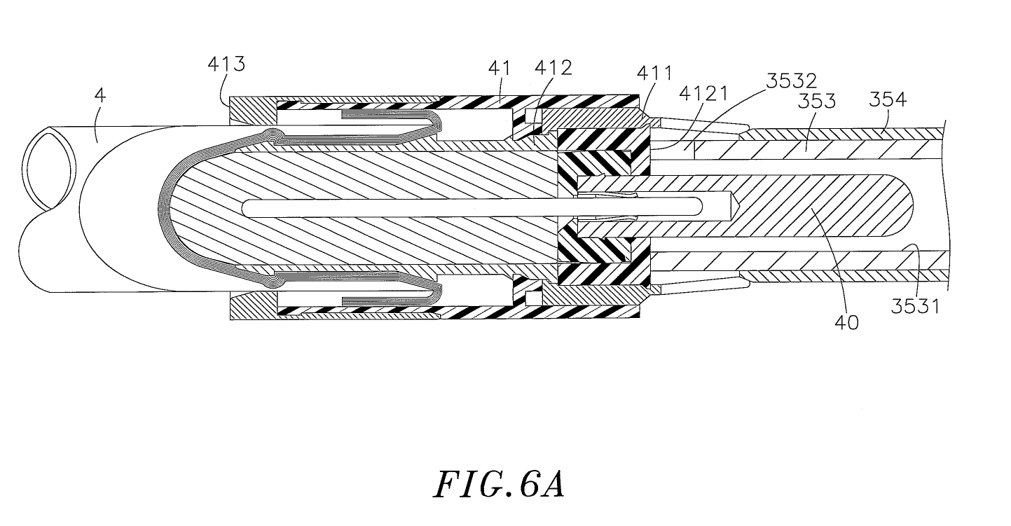

Referring to FIGS. 5, 5A, 6 and 6A and FIGS. 1, 2, 3, 4 and 4A again, the inner diameter of the collar 411 of the cable-end connector 41 varies from different models or different suppliers. If the inner diameter of the collar 411 is greater than the outer diameter of the sliding socket 354, the working head 353 with the sliding socket 354 can be directly inserted into the inside of the collar 411. If the inner diameter of the collar 411 is smaller than the outer diameter of the sliding socket 354 but greater than the working head 353 of the working device 35, attaching the collar 411 to the working head 353 will push the sliding socket 354 toward the locating block 34 to compress the spring member 355, and thus, the collar 411 can be attached to the working head 353 smoothly. When the lever 2 is biased at this time, the working head 353 of the working device 35 is continuously moved into the inside of the collar 411, and the sliding socket 354 is continuously moved by the collar 411 toward the locating block 34. When the biasing force is released from the lever 2 or the coaxial cable 4 is removed with the cable-end connector 41 out of the crimping tool, the spring member 355 immediately pushes back the sliding socket 354 toward the positioning block 13 to its former position.

When a coaxial cable 4 is attached with a different size of cable-end connector 41, it is not necessary to change the model of the crimping tool, i.e., the crimping tool of the invention is practical for crimping any of a variety of cable-end connectors 41 with a coaxial cable 4. When a coaxial cable 4 is attached with a cable-end connector 41 and inserted into the crimping tool for crimping, the working head 353 is accurately positioned in the axial center of the collar 411 of the loaded cable-end connector 41 and positively stopped against the stop flange 4121 of the core tube 412 of the loaded cable-end connector 41, facilitating accurate and rapid crimping with less effort.

In conclusion, the invention provides a crimping tool for crimping a coaxial cable 4 with a cable-end connector 41 of any size. The crimping tool comprises a tool body 1 having a receiving chamber 10 defined therein, two pivot holes 11 aligned at two opposite lateral sides near one end of the receiving chamber 10 and a positioning block 13 disposed in the opposite end of the receiving chamber 10, a lever 2 pivotally coupled to the two pivot holes 11 of the tool body 1, and a linking mechanism 3 comprising a link 32, two swivel pushrods 31 coupled between one end of the lever 2 and one end of the link 32, spring members 33 connected between the pivot between the level and the pivot holes 11 of the tool body 1 and the pivot between the swivel pushrods 31 and the link 32, a locating block 34 located on the other end of the link 32 remote from the swivel pushrods 31 and a working device 35 connected to the locating block 34. The working device 35 comprises a shank 352, a connection member 351 axially extended from one end of the shank 352 and fastened to the locating block 34, an expanded working head 353 located on the opposite end of the shank 352 remote from the connection member 351, a sliding socket 354 axially slidably coupled to the shank 352 and adapted for capping onto the working head 353, and a spring member 355 mounted around the shank 352 and stopped between the locating block 34 and the sliding socket 354 to force the sliding socket 354 onto the working head 353. If the inner diameter of the collar 411 of the cable-end connector 41 to be crimped is greater than the outer diameter of the sliding socket 354, the working head 353 with the sliding socket 354 can be directly inserted into the inside of the collar 411. If the inner diameter of the collar 411 is smaller than the outer diameter of the sliding socket 354 but greater than the working head 353 of the working device 35, attaching the collar 411 to the working head 353 will push the sliding socket 354 toward the locating block 34 to compress the spring member 355, and thus, the collar 411 can be attached to the working head 353 smoothly. Thus, the crimping tool of the invention is practical for crimping any of a variety of cable-end connectors 41 with a coaxial cable 4. When a coaxial cable 4 is attached with a cable-end connector 41 and inserted into the crimping tool for crimping, the working head 353 is accurately positioned in the axial center of the collar 411 of the loaded cable-end connector 41 and positively stopped against the stop flange 4121 of the core tube 412 of the loaded cable-end connector 41, facilitating accurate and rapid crimping with less effort.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A crimping tool for crimping a coaxial cable with a cable-end connector, comprising:
a tool body comprising a receiving chamber defined therein, two pivot holes aligned at two opposite lateral sides thereof near one end of said receiving chamber and a positioning block disposed in an opposite end of said receiving chamber;
a lever comprising a front connection portion, a rear operating portion backwardly extended from a rear end of said front connection portion, and a first pivot located on a front end of said front connection portion remote from said rear operating portion and pivotally connected between the two pivot holes of said tool body; and
a linking mechanism axially slidably coupled to said tool body inside said accommodation chamber and movable by said lever, said lining mechanism comprising a link having one end thereof pivotally connected to said front connection portion of said lever, a locating block located on an opposite end of said link and a working device connected to said locating block, said working device comprising a shank, a connection member axially extended from one end of said shank and fastened to said locating block, an expanded working head located on an opposite end of said shank remote from said connection member, a sliding socket axially slidably coupled to said shank and adapted for capping onto said working head, and a spring member mounted around said shank and stopped between said locating block and said sliding socket to force said sliding socket onto said working head.

2. The crimping tool as claimed in claim 1, wherein said lever further comprises a second pivot located on said front connection portion near one side of said front connection portion and spaced between said rear operating portion and said first pivot; said link comprises a first transverse coupling rod disposed at one end thereof and a second transverse coupling rod spaced from said first transverse coupling rod at a predetermined distance; said linking mechanism further comprises two swivel pushrods bilaterally pivotally connected between said second pivot of said lever and said first transverse coupling rod of said link.

3. The crimping tool as claimed in claim 2, wherein said linking mechanism further comprises a plurality of spring members connected between said first transverse coupling rod of said link and said first pivot of said lever.

4. The crimping tool as claimed in claim 1, wherein said tool body further comprises a first longitudinal sliding slot and a second longitudinal sliding slot cut through each of two opposite lateral sides thereof and horizontally aligned in line and disposed in communication with the receiving chamber; said link comprises a first transverse coupling rod disposed at one end thereof and slidably coupled to the first longitudinal sliding slots of said tool body and a second transverse coupling rod spaced from said first transverse coupling rod at a predetermined distance and slidably coupled to the second longitudinal sliding slots of said tool body.

5. The crimping tool as claimed in claim 1, wherein said working head of said working device comprises a receiving hole axially extending to a front end thereof and facing said positioning block, and a notch cut through the periphery thereof and facing the rear operating portion of said lever.

6. The crimping tool as claimed in claim 1, wherein said rear operating portion of said lever extends backwardly from the rear end of said front connection portion at an obtuse angle.
